(19) United States
(12) Patent Application Publication
(10) Pub. No.: US 2026/0205014 A1
(43) Pub. Date: Jul. 16, 2026

(54) CIRCUITS AND METHODS FOR CYCLE-BY-CYCLE AVERAGE INDUCTOR CURRENT SENSING IN DC-DC CONVERTERS

(71) Applicant: Empower Semiconductor, Inc., San Jose, CA (US)

(72) Inventors: Gabriel EIREA, Mountain View, CA (US); Trey ROESSIG, Palo Alto, CA (US); Kin Keung LAU, Belmont, CA (US)

(73) Assignee: Empower Semiconductor, Inc., San Jose, CA (US)

(21) Appl. No.: 19/019,140

(22) Filed: Jan. 13, 2025

(51) Int. Cl. H02M 3/158; H02M 3/00

(52) U.S. Cl. CPC H02M 3/1582; H02M 3/01

(57) ABSTRACT

A circuit is disclosed. The circuit includes a first switch coupled between a voltage source and a switch node, a second switch coupled between the switch node and a ground, an inductor coupled in parallel with the second switch, a controller arranged to: turn on the second switch causing a current to flow through the inductor and through the second switch for a first time period having a first duration, where during the first time period the current flowing through the inductor decreases, and generate a voltage that increases at a predetermined rate of change for a second time period, where the second time period starts at an end of the first time period and wherein a duration of the second time period equals the first duration of the first time period. In one aspect, the generated voltage initiates at an end of the first time period.

### FIELD

The described embodiments relate generally to power converters, and more particularly, the present embodiments relate to circuits and methods for cycle-by-cycle average inductor current sensing in DC-DC converters.

### BACKGROUND

A wide variety of electronic devices are available for consumers today. Many of these devices have integrated circuits that are powered by regulated low voltage DC power sources. These low voltage power sources are often generated by dedicated power converter circuits that use a higher voltage input from a battery or another power source. In some applications, the dedicated power converter circuit can be one of the largest power dissipating components of the electronic device and can sometimes consume more space than the integrated circuit that it powers. As electronic devices become more sophisticated and more compact, more efficient power converter circuits are called for.

### SUMMARY

In some embodiments, a circuit is disclosed. The circuit includes a first switch coupled between a voltage source and a switch node; a second switch coupled between the switch node and a ground; an inductor coupled in parallel with the second switch; a controller arranged to: turn on the second switch causing a current to flow through the inductor and through the second switch for a first time period having a first duration, where during the first time period the current flowing through the inductor decreases; and generate a voltage that increases at a predetermined rate of change for a second time period, where the second time period starts at an end of the first time period and where a duration of the second time period equals the first duration of the first time period.

In some embodiments, during the second time period the current flowing through the inductor decreases at a rate of change that is equal and opposite of the predetermined rate of change.

In some embodiments, the circuit further includes a third time period that starts at the end of the first time period and has a third duration that is greater than the first duration of the first time period, where the second switch remains on during the third time period; and where the controller is further configured to: generate a representative voltage at an end of the third duration where the representative voltage corresponds to the current flowing through the inductor at the end of the third duration; determine a voltage difference by subtracting the representative voltage from the generated voltage; and determine an average voltage that is representative of an average current flowing through the inductor by dividing the voltage difference by two.

In some embodiments, the circuit further includes a third time period that starts at the end of the first time period and has a third duration that is greater than the first duration of the first time period, where the second switch remains on during the third time period; and where the controller is further configured to: generate a representative voltage at an end of the third duration where the representative voltage corresponds to the current flowing through the inductor at the end of the third duration; and where the representative voltage is generated during the third time period and where an absolute value of a rate of change of the representative voltage is equal to an absolute value of the predetermined rate of change.

In some embodiments, the generated voltage at the end of the second time period is representative of a maximum of the current flowing through the inductor when the first switch is on.

In some embodiments, the generated voltage initiates at an end of the first time period.

In some embodiments, an absolute value of the predetermined rate of change is equal to an absolute value of rate of change of the representative voltage during the third time period.

In some embodiments, a circuit is disclosed. The circuit includes a first switch coupled between a switch node and a ground; an inductor coupled in parallel with the first switch; and a controller arranged to: turn on the first switch causing a current to flow from the inductor through the first switch for a first time period having a first duration; and generate a voltage that increases at a predetermined rate of change for a second time period, where the second time period starts at an end of the first time period and where a duration of the second time period equals the first duration of the first time period.

In some embodiments, the circuit further includes a third time period that starts at the end of the first time period and has a third duration that is greater than the first duration of the first time period, where the first switch remains on during the third time period; and where the controller is further configured to: generate a representative voltage at an end of the third duration where the representative voltage corresponds to the current flowing through the inductor at the end of the third duration; determine a voltage difference by subtracting the representative voltage from the generated voltage; and determine an average voltage that is representative of an average current flowing through the inductor by dividing the voltage difference by two.

In some embodiments, the circuit further includes a third time period that starts at the end of the first time period and has a third duration that is greater than the first duration of the first time period, where the first switch remains on during the third time period; and where the controller is further configured to: generate a representative voltage at an end of the third duration where the representative voltage corresponds to the current flowing through the inductor at the end of the third duration; and where the representative voltage is generated during the third time period and where an absolute value of a rate of change of the representative voltage is equal to an absolute value of the predetermined rate of change.

In some embodiments, the rate of change of the representative voltage is negative and where the predetermined rate of change is positive.

In some embodiments, the generated voltage at the end of the second time period is representative of a maximum of the current flowing through the inductor when the first switch is on.

In some embodiments, the generated voltage initiates at an end of the first time period.

In some embodiments, the first switch is a portion of a boost converter circuit.

In some embodiments, the first switch is a portion of a buck-boost converter circuit.

In some embodiments, a circuit is disclosed. The circuit includes a first switch coupled between a voltage source and a switch node; a second switch coupled between the switch node and a ground; an inductor coupled between the switch node and the ground; and a controller arranged to: turn on the first switch causing a current to flow from the voltage source into the inductor; turn off the first switch and turn on the second switch causing the current in the inductor to flow through the second switch for a first time period having a first duration; detect a first voltage corresponding to the current in the inductor at an end of the first time period; and generate a second voltage at an end of a second time period, where the second voltage is equal to the first voltage and the second time period has a duration that is equal to the first duration.

In some embodiments, the controller is further arranged to detect a rate of change of a voltage corresponding to the current in the inductor during a third time period.

In some embodiments, the controller is further arranged to generate a third voltage having a rate of change that is half the rate of change of the voltage corresponding to the current in the inductor during the third time period.

In some embodiments, the third time period starts at the end of the first time period and has a third duration that is greater than the first duration of the first time period, where the second switch remains on during the third time period.

In some embodiments, the controller is further arranged to subtract the third voltage from the second voltage to generate a fourth voltage at an end the third time period, the fourth voltage having a value representative of an average current in the inductor.

### BRIEF DESCRIPTION OF THE DRAWINGS

FIG. 1 illustrates a dc-dc buck converter circuit with a cycle-by-cycle average inductor sensing, according to certain embodiments;

FIG. 2 illustrates operating waveforms for operation of the circuit of FIG. 1 illustrating methods to determine average inductor current, according to certain embodiments;

FIG. 3A illustrates a high-level schematic of a circuit implementation of the method of determining cycle-by-cycle average inductor, according to some embodiments. FIG. 3B illustrates a schematic of a circuit implementation of the method described in FIG. 3A, according to some embodiments. FIG. 3C illustrates a schematic of a circuit implementation for generation of control signals in FIG. 3B, according to some embodiments;

FIG. 4 illustrates operating waveforms of the circuit 350 during one PWM period, according to some embodiments;

FIG. 5 illustrates a schematic of a circuit implementation of the method described above, according to certain embodiments; and

FIG. 6 illustrates operating waveforms of the circuit of FIG. 5 during one PWM period, according to some embodiments.

### DETAILED DESCRIPTION

Circuits, devices and related techniques disclosed herein relate generally to power converters. More specifically, circuits, devices and related techniques disclosed herein relate to cycle-by-cycle average inductor current sensing and determination in DC-DC converters. In some embodiments, a current sense circuit may be coupled to a low-side switch in a DC-DC converter. The current sense circuit may be arranged to sense a current in the low side switch. During operation of a DC-DC converter, a high-side switch may be turned on causing a current to flow in an inductor that is coupled to the high-side and low-side switches at a switch node. In various embodiments, the current sense circuit may be part of a controller circuit that is arranged to control a conductivity state of high-side and low-side switches. When the high-side switch turns off, the current in the inductor may flow through the low-side FET. Due to noise and settling time of the sensing circuit, a blanking time period may be applied to the current sense circuit where the current sense information for the peak inductor current may not be available. Circuits and methods disclosed herein enable determination of the peak inductor current. Further, embodiments of the disclosure enable determining average inductor current by summing the peak inductor current and the valley inductor current when the high-side switch is off. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

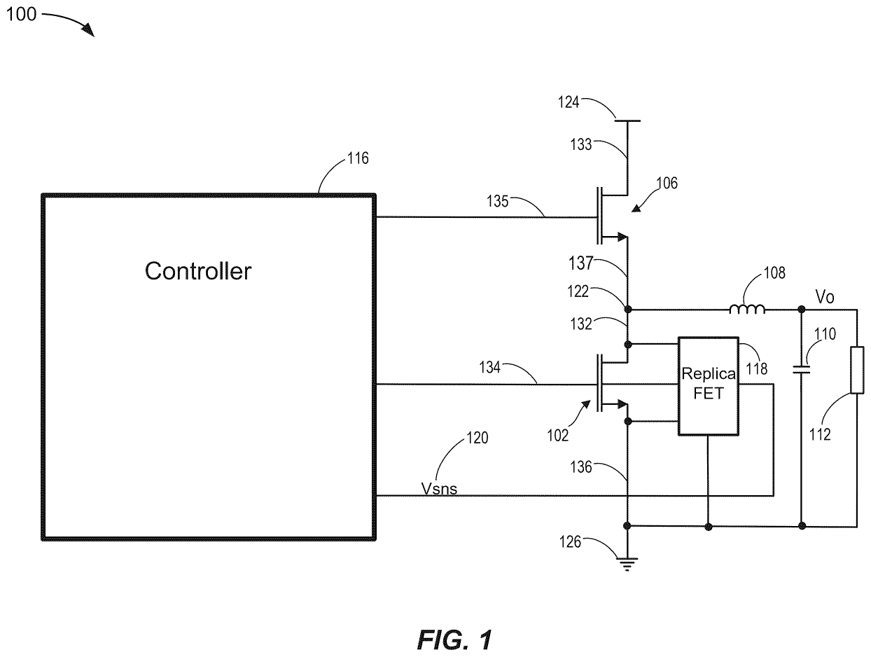

FIG. 1 illustrates a DC-DC buck converter circuit with a cycle-by-cycle average inductor sensing, according to certain embodiments. In the illustrated embodiment, circuit 100 can include a switch 102 coupled to a switch 106 at a switch node 122, an inductor 108 coupled to the switch node, and a controller circuit 116 coupled to switches 102 and 106. The switch 102 can include a first drain terminal 132, a first gate terminal 134 and a first source terminal 136. The switch 106 can include a second drain terminal 133, a second gate terminal 135 and a second source terminal 137. Cycle-by-cycle operation may also be referred to as operation during each period of a pulse width modulated (PWM) of the power converter. In some embodiments, the switches 102 and 106 may be transistors. In various embodiments, the transistors may be field effect transistors (FET). In some embodiments, the transistors may be metal-oxide-semiconductor field effect transistors (MOSFETS).

The first source terminal can be coupled to a ground 126. The second drain terminal 133 can be coupled to an input voltage 124. The inductor 108 can be coupled to a capacitor 110 and to a load 112. A current sense circuit 118 that can be coupled to the switch 102. The current sense circuit 118 can be coupled to the first drain terminal 132 and to the first source terminal 136. In some embodiments, the current sense circuit 118 can include a sense FET that is coupled in parallel with the switch 102. The sense FET may also be referred to as a replica FET. In some embodiments, the controller circuit 116 can include the current sense circuit 118.

The current sense circuit 118 can be arranged to generate a sensed voltage 120 labeled Vsns that is representative of the current flowing in the switch 102. In some embodiments, the current sense circuit 118 may be included in the controller circuit 116. The control circuit 116 can be arranged to control conductivity states of the switches 102 and 106. The control circuit 116 can further be arranged to receive the sensed voltage 120 and generate corresponding drive signals for the switches 102 and 106. In some embodiments, the circuit 100 can be arranged to sense a first voltage corresponding to a first current in the inductor at an end of a first blanking time period during an off-time period of the switch 106. Circuit 100 can also be arranged to generate a second voltage by adding the first voltage to a ramp voltage during a second blanking period during the off-time period of the switch 106. The ramp voltage may a positive rate of change with respect to time. In some embodiments, the first blanking period may be equal to the second blanking period. Circuit 100 can sense a third voltage at the end of the off-time period of the switch 106, and then generate an average voltage corresponding to an average of the current in the inductor 108 by dividing a sum of the second voltage to the third voltage by two.

In various embodiments, circuit 100 can be arranged to sense a first voltage corresponding to a first current in the inductor at an end of a first blanking time period during an off-time period of the switch 106. Circuit 100 can also be arranged to generate a second voltage at an end of a second blanking time period, where the second voltage is equal to the first voltage and the second time period has a duration that is equal to the first duration. Circuit 100 can also be arranged to detect a rate of change of a voltage corresponding to the current in the inductor off-time period of the switch 106. Circuit 100 can additionally be arranged to generate a third voltage having a rate of change that is half the rate of change of the voltage corresponding to the current in the inductor during the off-time period of the switch 106. Circuit 100 may also be arranged to subtract the third voltage from the second voltage to generate a fourth voltage at an end the off-time period of the switch 106, the fourth voltage having a value representative of an average current in the inductor.

A current in the inductor 108 can be sensed and converted to a voltage using the current sense circuit 118 that is coupled to the switch 102. In some embodiments, current sense circuit 118 may include a sensing resistor Rsns that may be trimmed. The sensed current can be a replica of the current in the switch 102. During an on-time of the switch 106, a current can flow from the input voltage 124 in the inductor 108, causing the current in the inductor 108 to increase. During an off-time of the switch 106, the current in the inductor 108 can flow in the switch 102 and may decrease. In some embodiments, there may be a blanking time period at the start of the off-time of the switch 106 during which a sensed inductor current may be noisy. In current approaches, the peak inductor information may be blanked out and may not be available.

In some embodiments, the current sense circuit 118 may be coupled to the switch 106 instead of switch 102, and can be arranged to detect a current flowing through the switch 106. It shall be understood that the methods described herein can be used for detecting peak current of the switch 106 when the duty cycle is high with peak current mode controlled.

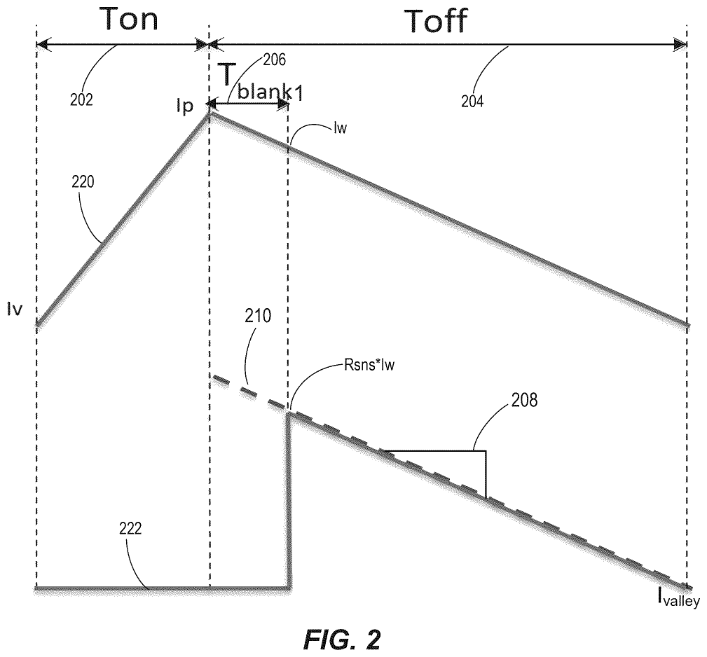

FIG. 2 illustrates graphs for an operation of the circuit 100 showing methods to determine an average inductor current, according to certain embodiments. Graph 220 shows the inductor current, while graph 222 shows a sensed voltage corresponding to the graph 220. As shown in FIG. 2, when the switch 106 is on, a current may flow from the input voltage 124 through the inductor 108 during time 202 (Ton). During the on-time of the switch 106, the current in the inductor 108 can increase reaching a peak value Ip. Next, the switch 106 may be turned off and the switch 102 may be turned on by the controller circuit 116. The current in the inductor 108 can start to decrease during time period 204 (Toff) and continue to decrease to a value of I_{valley}. Graph 222 may decrease with a slope 208. During first portion of the time period 204, there may be a blanking time period 206 labeled T_{blank1}. During time period 206, the sensed current information may not be available due to noise and settling time of the sensing circuit.

Embodiment of the disclosure enable determination of an actual value of the peak inductor current by use of the blanking time period 206 and use of a slope of the inductor current in the time period 204. In some embodiments, a value of the sensed inductor current at the end of the blanking time period 206 may be detected (Iw). A ramp can be started such that a positive slope of this ramp can have the same magnitude as the negative slope 210. The positive sloped ramp may be discontinued after a time period equal to the blanking time period 206. A final value of the ramp can indicate the peak inductor current value. In this way, at the end of the time period 204 the peak inductor value and the sensed valley inductor current value have been determined. An average of these two values can be obtain by adding these two values to generate the average inductor current value during the off-time of the switch 106. The obtained average inductor current value can be equal the steady-state inductor current.

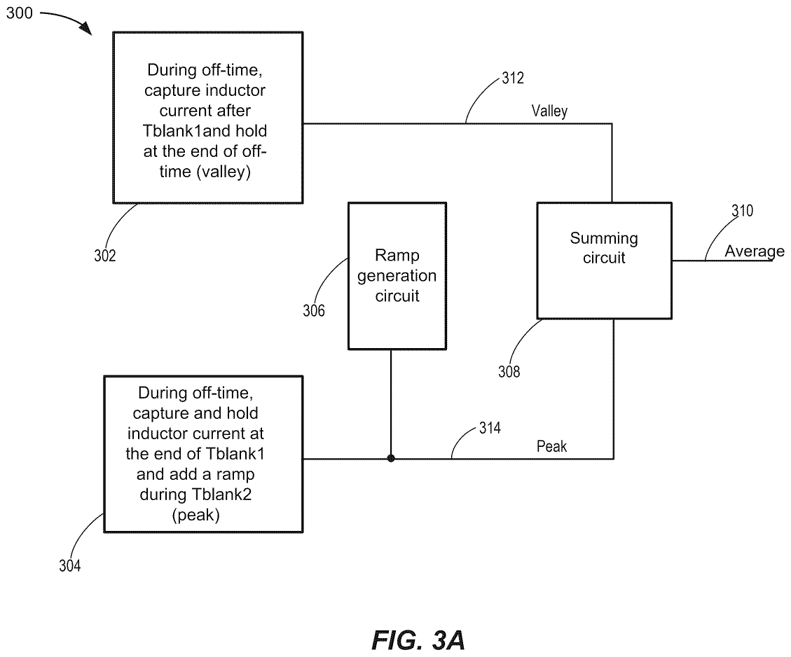

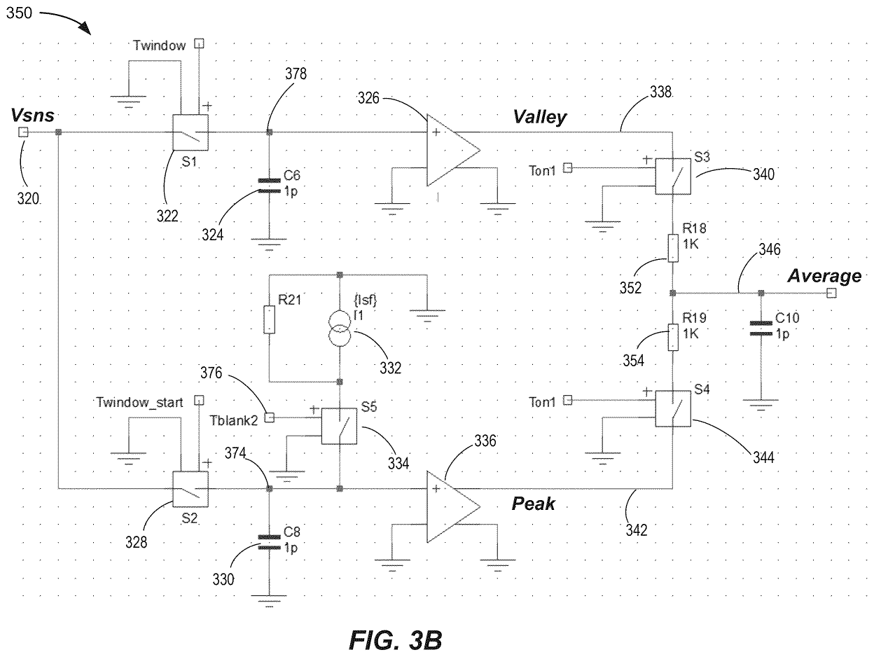

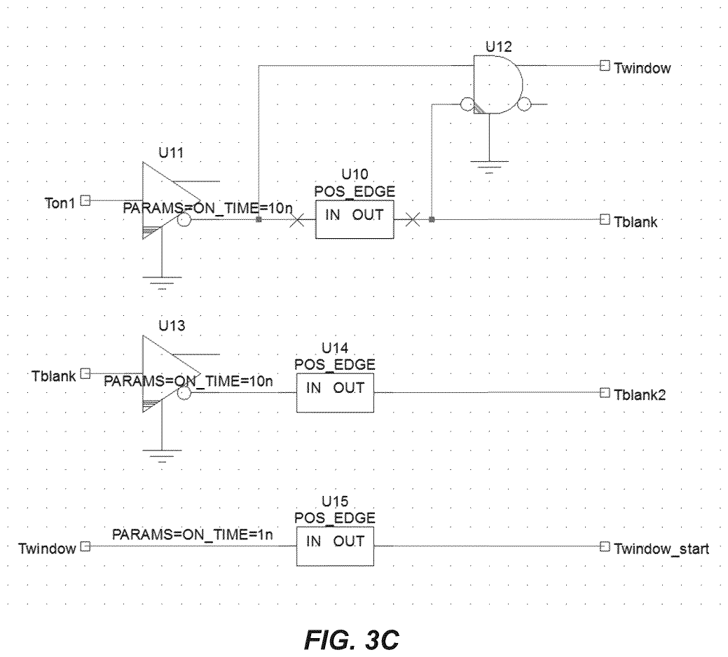

FIG. 3A illustrates a high-level schematic of a circuit implementation of the method described above, according to some embodiments. In FIG. 3A, a circuit 300 can include a first circuit 302 that is arranged to capture and hold, during off-time of the switch 106, the inductor current after first blanking period Tblank1. This is value is the valley inductor current. The circuit 300 can also include a second circuit 304 that is arranged to capture, during off-time of the switch 106, the inductor current, and hold it at the end of Tblank1. The circuit 300 can further include a third circuit 306 that can include a ramp generator circuit that is arranged to generate a positive sloped ramp, during Tblank2, to recreate peak inductor current. The second circuit 304 and third circuit 306 are arranged to generate a value for the peak inductor current. Circuit 300 can additionally include a circuit 308 that is arranged to add signals at node 314 and 312 to generate an average inductor current at node 310.

FIG. 3B illustrates a schematic of a circuit implementation of the method described above, according to some embodiments. In FIG. 3B, circuit 350 can include an input terminal that is arranged to receive a signal Vsns corresponding to a sensed inductor current. A switch 322 can be coupled to the input terminal 320 and also coupled to a capacitor 324. The capacitor 324 can be coupled to an amplifier 326. The input terminal 320 can also be coupled to a switch 328. The switch 328 can be coupled to a capacitor 330. The capacitor 330 can be coupled to an amplifier 336 and also coupled switch 334. The switch 334 can coupled to a current source 332 having a current Isf.

Amplifier 326 can be arranged to generate a signal at node 338 that is indicative an inductor current valley. The amplifier 336 along with the current source and capacitor 330 are arranged to generate a signal at node 342 that is indicative an inductor current peak. The circuit 350 can further include a switch 340 coupled to the amplifier 326. A switch 344 can be coupled to the amplifier 336. The switch 340 can be coupled to a resistor 352 and the switch 344 can be coupled to a resistor 354. Resistors 352 and 354 can be coupled together at output terminal 346. An output of the circuit 350 can be generated at output terminal 346.

FIG. 3C illustrates a schematic of a circuit implementation for generation of control signals Twindow, Tblank (Tblank1), Tblank2, and Twindow_start in FIG. 3B, according to some embodiments. In FIG. 3C, an edge detector may be used having an on-time, for example, 10 ns for Tblank (Tblank1) and Tblank2, and 1 ns for Twindow_start. Ton1 may be the on-time of phase 1 in circuit 350 circuit.

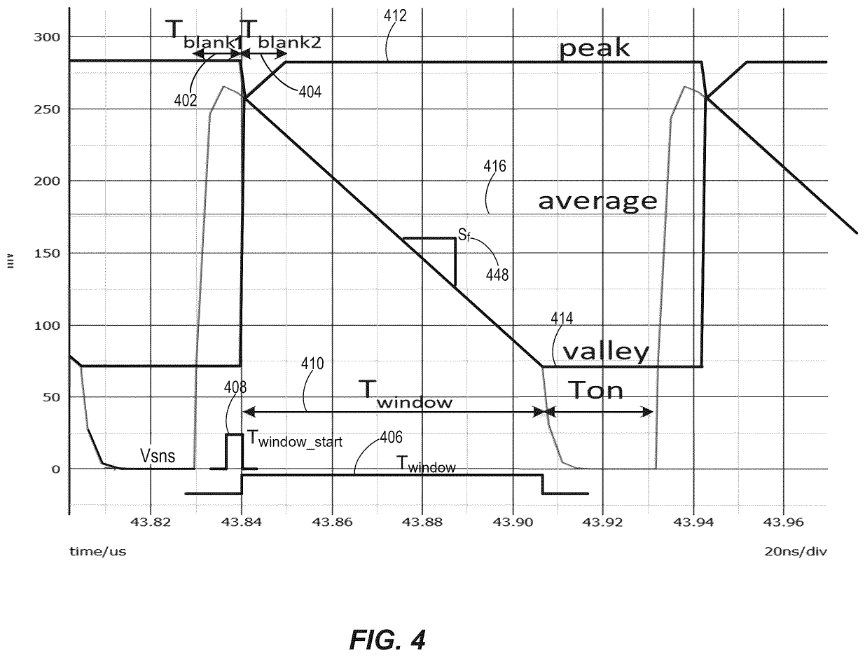

FIG. 4 illustrates operating waveforms of the circuit 350 during one PWM period, according to some embodiments. Referring to FIGS. 1, 3B and 4, circuit 350 can be arranged to receive the signal Vsns at the input terminal 320. Signal Vsns can correspond to sensed current in the inductor 108. During time period 402 (Tblank1) when switch 106 turns off and switch 102 turned on, signal Vsns may rise. Signal 408 (Twindow_start) may turn on causing the switch 328 to close, thereby causing the signal Vsns to be transmitted to capacitor 330. Once signal 408 turns off, the capacitor 330 can hold the value of Vsns. Subsequent to signal 408 turning off, signal 406 (Twindow) can turn on causing switch 322 to close, causing the value of Vsns at the end of time period 404 (Tblank2) to be transmitted to the capacitor 324. For the remainder of time period 410, switch 322 may stay closed causing the voltage at node 378 to follow Vsns. The voltage at node 378 is buffered by the amplifier 32 to generate a signal at node 338 that can represent a value of the inductor valley current (reference 414 in FIG. 4).

During time period 404, a signal 376 may cause the switch 334 to close causing the current source 332 to sink current into the capacitor 330, thereby causing a voltage at node 374 to rise. The value of current source 332 can be such that a slope of the ramp of the voltage at node 374 can be equal to the sensed inductor current ramp slope 448 given by S_{f}=Rsns*Vo/L, where Rsns is a value of the resistance of the sensing resistor, Vo is the output voltage of the buck converter and L is a value of the inductance of the inductor 108. In FIG. 4 the waveforms of the circuit are presented during one PWM period This voltage can then be added to the original Vsns voltage after time period 402 and can be buffered by amplifier 336 to generate a signal at node 342 that corresponds to the peak inductor value (reference 412 on FIG. 4). Subsequently, switches 340 and 344 can be closed causing the signal at nodes 338 and 342 to be summed up onto output terminal 346. The signal at output terminal 346 is an average value (reference 416 on FIG. 4). It shall be understood that describe embodiments is an example implementation of the methods disclosed herein. Other implementation circuits to perform disclosed methods such as, but not limited to, peak inductor current reconstruction and averaging the peak and the valley current values are within the scope of this disclosure.

In some embodiments a circuit can include a first switch coupled between a voltage source and a switch node; a second switch coupled between the switch node and a ground; an inductor coupled in parallel with the second switch; a controller arranged to: turn on the second switch causing current to flow through the inductor and through the second switch for a first time period having a first duration, where during the first time period the current flowing through the inductor decreases; and generate a voltage that increases at a predetermined rate of change for a second time period, where the second time period starts at an end of the first time period and where a duration of the second time period equals the first duration of the first time period. In one aspect, during the second time period the current flowing through the inductor decreases at a rate of change that is equal and opposite of the predetermined rate of change. Equal and opposite can be defined as the slope of the relationship is equal, but the sign of the slope is opposite, even though one is a current and the other is a voltage, the slope may be the same.

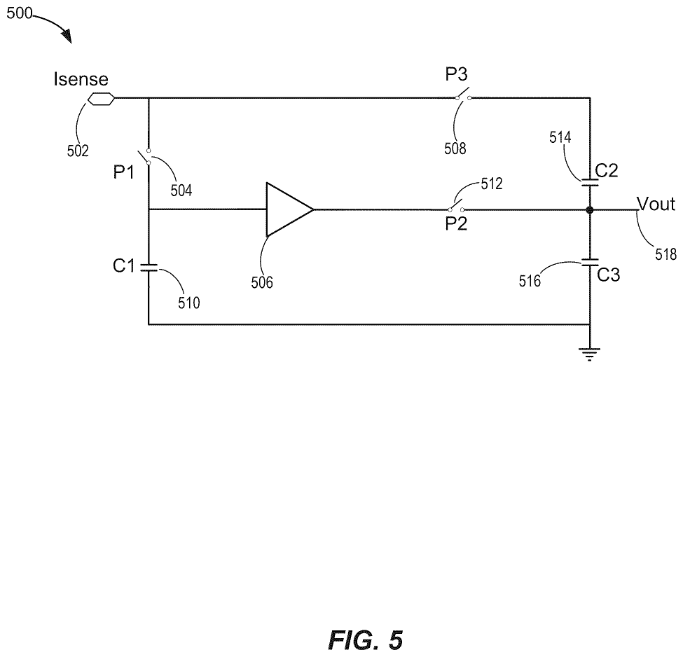

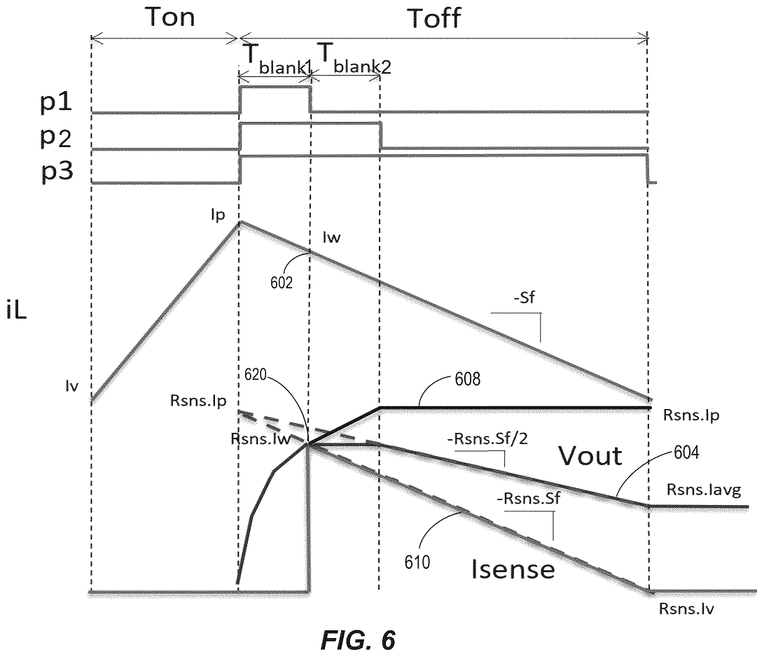

FIG. 5 illustrates a schematic of a circuit implementation of the method described above, according to certain embodiments. FIG. 6 illustrates operating waveforms of the circuit of FIG. 5 during one PWM period, according to some embodiments. Circuit 500 can include input terminal 502 arranged to receive a signal corresponding to a sense inductor current. The input terminal 502 can be coupled to a switch 508 and a switch 504. Switch 508 can be coupled to buffer 506 and to a capacitor 510 having a capacitance C1. The buffer 506 can be coupled to a switch 512. Switch 512 can be coupled to a capacitor 514 having a capacitance C2 and a capacitor 516 having a capacitance C3. In some embodiments, capacitance C1, C2 and C3 may have equal values. Capacitors 514 and 516 may be coupled to an output terminal 518.

Circuit 500 may not include a ramp generation circuit. Circuit 500 may use the same ramp signal as that of the sensed inductor current and may perform a rolling average with the peak current. Circuit 500 may hold a value 602 labeled I_{w} during time period Tblank2 in lieu of using a ramp generation circuit. A signal at the end of time period Tblank2 may have a value equal to an average of the sensed inductor current and the peak inductor current. Subsequent to that, the signal may ramp down at half the rate of the sensed inductor current, such that at the end of the time period Toff, it can have a value that is an average of the peak and the valley values.

Referring to FIGS. 1, 5 and 6, during time period Ton the switch 106 may be on causing the current in the inductor 108 to increase from a value Iv (valley) to a value Ip (peak). At the end of time period Ton, the switch 10 may be turned off and switch 102 may be turned on. Further, at the end of time period Ton, switches 504 (P1), 512 (P2) and 508 (P3) may be turned on. At the end of the time period Tblank1, switch 504 may be turned off, while at the end of time period Tblank2, switch 512 (P2) may be turned off. At the end of time period Toff, switch 504 (P3) can be turned off. During Toff period, the switch 106 is off and switch 102 is on.

Graph 604 shows the output signal Vout at the output terminal 518. Graph 608 shows a voltage signal representative a value of peak inductor current (Ip). Graph 610 shows a voltage signal corresponding to a value of valley inductor current (Iv). Graph 604 can be generated by holing the value at 620 for time period Tblank2and then reduce its value by a slope that is half the slope of graph 610. Circuit 500 can be arranged to during off-time of the switch 106, sense and record a first current in the inductor 108 after a first blanking time period, and hold the first current the inductor 108 for a second blanking time period. Subsequently, circuit 500 can be arranged to add half of the first current to the second current to generate an average of the current in the inductor 108.

In some embodiments, combination of the circuits and methods disclosed herein can be utilized to provide cycle-by-cycle average inductor current value. Although circuits and methods are described and illustrated herein with respect to several particular configuration of dc-dc buck converter circuits, embodiments of the disclosure are suitable for providing cycle-by-cycle average inductor current value in other power converter circuits, such as, but not limited to, boost and buck-boost circuits. In various embodiments, disclosed average inductor current sensing techniques can be used for a boost converter circuit having a boost switch. In some embodiments, disclosed average inductor current sensing techniques can be used for a buck-boost converter circuit having a main switch.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A circuit comprising:
a first switch coupled between a voltage source and a switch node;
a second switch coupled between the switch node and a ground;
an inductor coupled in parallel with the second switch;
a controller arranged to:
turn on the second switch causing a current to flow through the inductor and through the second switch for a first time period having a first duration, wherein during the first time period the current flowing through the inductor decreases; and
generate a voltage that increases at a predetermined rate of change for a second time period, wherein the second time period starts at an end of the first time period and wherein a duration of the second time period equals the first duration of the first time period.

2. The circuit of claim 1, wherein during the second time period the current flowing through the inductor decreases at a rate of change that is equal and opposite of the predetermined rate of change.

3. The circuit of claim 1, further comprising a third time period that starts at the end of the first time period and has a third duration that is greater than the first duration of the first time period, wherein the second switch remains on during the third time period; and
wherein the controller is further configured to:
generate a representative voltage at an end of the third duration wherein the representative voltage corresponds to the current flowing through the inductor at the end of the third duration;
determine a voltage difference by subtracting the representative voltage from the generated voltage; and
determine an average voltage that is representative of an average current flowing through the inductor by dividing the voltage difference by two.

4. The circuit of claim 1, further comprising a third time period that starts at the end of the first time period and has a third duration that is greater than the first duration of the first time period, wherein the second switch remains on during the third time period; and
wherein the controller is further configured to:
generate a representative voltage at an end of the third duration wherein the representative voltage corresponds to the current flowing through the inductor at the end of the third duration; and
wherein the representative voltage is generated during the third time period and wherein an absolute value of a rate of change of the representative voltage is equal to an absolute value of the predetermined rate of change.

5. The circuit of claim 1, wherein the generated voltage at the end of the second time period is representative of a maximum of the current flowing through the inductor when the first switch is on.

6. The circuit of claim 1, wherein the generated voltage initiates at an end of the first time period.

7. The circuit of claim 4, wherein an absolute value of the predetermined rate of change is equal to an absolute value of rate of change of the representative voltage during the third time period.

8. A circuit comprising:
a first switch coupled between a switch node and a ground;
an inductor coupled in parallel with the first switch; and
a controller arranged to:
turn on the first switch causing a current to flow from the inductor through the first switch for a first time period having a first duration; and
generate a voltage that increases at a predetermined rate of change for a second time period, wherein the second time period starts at an end of the first time period and wherein a duration of the second time period equals the first duration of the first time period.

9. The circuit of claim 8, further comprising a third time period that starts at the end of the first time period and has a third duration that is greater than the first duration of the first time period, wherein the first switch remains on during the third time period; and
wherein the controller is further configured to:
generate a representative voltage at an end of the third duration wherein the representative voltage corresponds to the current flowing through the inductor at the end of the third duration;
determine a voltage difference by subtracting the representative voltage from the generated voltage; and
determine an average voltage that is representative of an average current flowing through the inductor by dividing the voltage difference by two.

10. The circuit of claim 8, further comprising a third time period that starts at the end of the first time period and has a third duration that is greater than the first duration of the first time period, wherein the first switch remains on during the third time period; and
wherein the controller is further configured to:
generate a representative voltage at an end of the third duration wherein the representative voltage corresponds to the current flowing through the inductor at the end of the third duration; and
wherein the representative voltage is generated during the third time period and wherein an absolute value of a rate of change of the representative voltage is equal to an absolute value of the predetermined rate of change.

11. The circuit of claim 10, wherein the rate of change of the representative voltage is negative and wherein the predetermined rate of change is positive.

12. The circuit of claim 8, wherein the generated voltage at the end of the second time period is representative of a maximum of the current flowing through the inductor when the first switch is on.

13. The circuit of claim 8, wherein the generated voltage initiates at an end of the first time period.

14. The circuit of claim 8, wherein the first switch is a portion of a boost converter circuit.

15. The circuit of claim 8, wherein the first switch is a portion of a buck-boost converter circuit.

16. A circuit comprising:
a first switch coupled between a voltage source and a switch node;
a second switch coupled between the switch node and a ground;
an inductor coupled between the switch node and the ground; and
a controller arranged to:
turn on the first switch causing a current to flow from the voltage source into the inductor;
turn off the first switch and turn on the second switch causing the current in the inductor to flow through the second switch for a first time period having a first duration;
detect a first voltage corresponding to the current in the inductor at an end of the first time period; and
generate a second voltage at an end of a second time period, wherein the second voltage is equal to the first voltage and the second time period has a duration that is equal to the first duration.

17. The circuit of claim 16, wherein the controller is further arranged to detect a rate of change of a voltage corresponding to the current in the inductor during a third time period.

18. The circuit of claim 17, wherein the controller is further arranged to generate a third voltage having a rate of change that is half the rate of change of the voltage corresponding to the current in the inductor during the third time period.

19. The circuit of claim 18, wherein the third time period starts at the end of the first time period and has a third duration that is greater than the first duration of the first time period, wherein the second switch remains on during the third time period.

20. The circuit of claim 19, wherein the controller is further arranged to subtract the third voltage from the second voltage to generate a fourth voltage at an end the third time period, the fourth voltage having a value representative of an average current in the inductor.
